(19) United States
(12) Patent Application Publication
(10) Pub. No.: US 2013/0326527 A1
(43) Pub. Date: Dec. 5, 2013

(54) SCHEDULING METHOD, SYSTEM DESIGN SUPPORT METHOD, AND SYSTEM

(71) Applicant: FUJITSU LIMITED, Kawasaki-shi (JP)

(72) Inventors: Takahisa SUZUKI, Kawasaki (JP); Koichiro YAMASHITA, Hachioji (JP); Hiromasa YAMAUCHI, Kawasaki (JP); Koji KURIHARA, Kawasaki (JP); Toshiya OTOMO, Kawasaki (JP); Naoki ODATE, Akiruno (JP); Tetsuo HIRAKI, Kawasaki (JP)

(73) Assignee: FUJITSU LIMITED, Kawasaki-shi (JP)

(21) Appl. No.: 13/963,506

(22) Filed: Aug. 9, 2013

Related U.S. Application Data
(63) Continuation of application No. PCT/JP2011/052953, filed on Feb. 10, 2011.

(51) Int. Cl. G06F 9/48

(52) U.S. Cl. CPC G06F 9/4881
USPC 718/102

(57) ABSTRACT

A scheduling method is executed by a processor, and includes detecting a transition from a first process to a second process; acquiring from memory, an operating frequency and a CPU count for executing the second process; suspending a CPU under operation or starting a suspended CPU, based on the CPU count; and assigning the operating frequency to a CPU that is to execute the second process.

### CROSS REFERENCE TO RELATED APPLICATIONS

This application is a continuation application of International Application PCT/JP2011/052953, filed on Feb. 10, 2011 and designating the U.S., the entire contents of which are incorporated herein by reference.

### FIELD

The embodiments discussed herein are related to a scheduling method and system that schedule the execution of programs. The embodiments are further related to a system design support method.

### BACKGROUND

A conventional scheduling technique of suppressing the amount of heat generated at a load peak in a multi-core processor system, achieves uniform power consumption per unit time (see, e.g., Japanese Patent No. 3567354).

Dynamic voltage frequency scaling (DVFS) for dynamically changing the clock frequency and source voltage that are supplied to a central processing unit (CPU) is known as a conventional technique for reducing power consumption in a multi-core processing system. In the multi-core processing system, processing speed is raised by causing multiple CPUs to execute given processes distributed thereto.

The processing time of the multi-core processor system is proportional to the operating CPU count. Thus, according to a known technique, the processing time and power consumption are calculated for various counts of operating CPUs to determine the optimum operating CPU count, the optimum source voltage value, and the optimum clock frequency (hereinafter “conventional technique”) (see, e.g., Japanese Laid-Open Patent Application No. 2005-85164). However, parallel processing using the multi-core processor system creates parallel processing overhead. Consequent to the parallel processing overhead, the processing speed cannot be raised in proportion to the operating CPU count in an actual practice.

FIG. 23 is an explanatory diagram of an example of parallel processing overhead. Parallel processing overhead results for two major reasons. One reason is that a program cannot be run entirely by parallel processing. For example, a program may have a portion allowing parallel processing and a portion not allowing parallel processing. If the portion not allowing parallel processing accounts for 10% of the execution time for the program run by one CPU, the 10%-portion not allowing parallel processing becomes a hindrance in the parallel processing even if multiple CPUs are present. Thus, performance that is 10 times or greater than the original performance cannot be achieved.

The other reason is that when one process is divided into sub-processes that are executed in parallel processing by multiple CPUs, synchronization and communication between the sub-processes distributed among the CPUs becomes necessary (synchronization/communication portions indicated in FIG. 23). Thus, execution by 2 or more CPUs additionally requires synchronization and communication processes that are not required in the case of execution by one CPU. In the case of execution by two or more CPUs, when one CPU is executing the portion not allowing parallel processing, other CPUs remain idle (idle portion).

FIG. 24 is an explanatory diagram of an example of an effect of parallel processing overhead. In a graph of FIG. 24, the vertical axis represents the performance and the horizontal axis represents the CPU count. This graph indicates the extent to which performance is improved by an increase in the operating CPU count in a case where the performance is defined as 1 when the operating CPU count is 1. The performance is expressed in terms of processing time. For example, if the processing time decreases from 40 [ms] to 20 [ms], the performance has doubled. An ideal value in the graph indicates that an increase in the operating CPU count is proportional to an increase in the performance. However, an actual performance curve in the graph demonstrates that as the operating CPU count increases, improvement in the performance becomes slower.

According to another technique, an idle time for each CPU is identified by analyzing an application to maintain the maximum performance and at the same time, the frequency of a clock supplied to the CPU is changed using DVFS to reduce power consumption (hereinafter “conventional technique 2”) (see, e.g., Japanese Laid-Open Patent Application No. 2006-293768). For example, the conventional technique 2 involves three processes A, B, and C, among which the process C uses the results of the processes A and B. The process C, therefore, cannot be started until the processes A and B have ended. It is assumed that the process A and the process B are completed in 5 seconds and 10 seconds, respectively, at a given reference frequency, and that the process A and the process B are executed separately by different CPUs. In this case, even if the frequency of a clock for execution of the process A supplied to the CPU that executes the process A is reduced to the half of the reference frequency, the start time of the process C does not change. Thus, power consumption can be reduced by DVFS.

Nonetheless, the conventional technique 2 poses a problem in that when multiple applications are executed simultaneously, the clock frequency cannot be changed because the way in which the idle time changes is unknown. In a case of a cellular phone, performance is less important when the user is working on an e-mail for a long time. Not performing parallel processing can be more efficient when overhead caused by synchronization and communication between processors is taken into consideration. The conventional technique 2 does not given consideration to such a possibility and attempts to perform parallel processing using all CPUs as much as possible. As a result, the use of the conventional technique 2 leads to a problem of increased power consumption.

### SUMMARY

According to an aspect of an embodiment, a scheduling method is executed by a processor, and includes detecting a transition from a first process to a second process; acquiring from memory, an operating frequency and a CPU count for executing the second process; suspending a CPU under operation or starting a suspended CPU, based on the CPU count; and assigning the operating frequency to a CPU that is to execute the second process.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an example of an embodiment;

FIG. 2 is an explanatory diagram of an example of hardware of a multi-core processor system;

FIG. 3 is a block diagram of a hardware configuration of a system design support apparatus according to the embodiments;

FIG. 4 is an explanatory diagram of a functional block configuration of a system design support apparatus 300 according to a first embodiment;

FIGS. 5A and 5B are explanatory diagrams of an example of measurement data;

FIG. 6 is an explanatory diagram of an example of a DVFS control information table 600;

FIG. 7 is a flowchart of an example of a design support procedure by the system design support apparatus 300 of the first embodiment;

FIG. 8 is a functional block diagram of a multi-core processor system 200 of a second embodiment;

FIG. 9 is an explanatory diagram of an example of the occurrence of an event;

FIG. 10 is an explanatory diagram of an example in which the number of CPUs under operation changes;

FIG. 11 is a flowchart of an example of a control procedure by an OS 220 of the second embodiment;

FIG. 12 is an explanatory diagram of a functional block configuration of the system design support apparatus 300;

FIGS. 13A and 13B are explanatory diagrams of examples of operation time tables;

FIG. 14 is an explanatory diagram of an example of a frequency/power table;

FIG. 15 is a flowchart of an example of a design support procedure by the system design support apparatus 300 of a third embodiment;

FIG. 16 is a functional block diagram of the multi-core processor system 200 of a fourth embodiment;

FIG. 17 is an explanatory diagram of an example in which multiple programs are executed simultaneously;

FIG. 18 is an explanatory diagram of a total operation time;

FIG. 19 is an explanatory diagram of an example in which the CPU count that minimizes power consumption is identified;

FIG. 20 is an explanatory diagram of an example of a change in an operating CPU count;

FIGS. 21 and 22 are flowcharts of an example of a control procedure by the OS 220 of the fourth embodiment;

FIG. 23 is an explanatory diagram of an example of parallel processing overhead; and

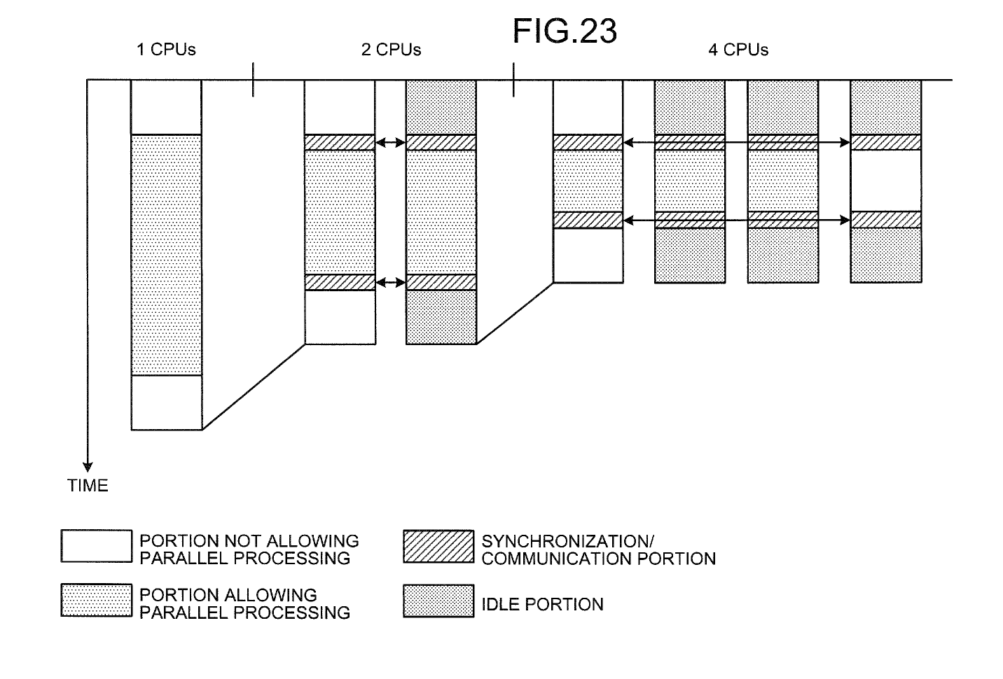

FIG. 24 is an explanatory diagram of an example of an effect of parallel processing overhead.

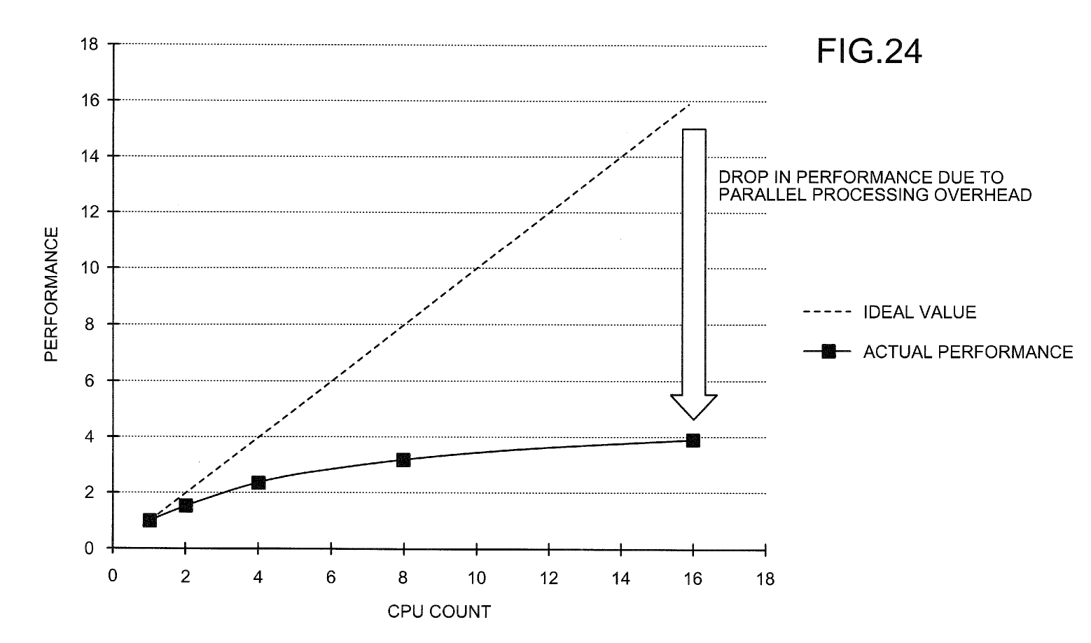

### DESCRIPTION OF EMBODIMENTS

Embodiments of a scheduling method, a system design support method, and a system according to the present invention will be described in detail with reference to the accompanying drawings. In a multi-core processor system, a multi-core processor is a processor equipped with multiple cores. The multi-core processor may take the form of a single processor equipped with multiple cores or the form of a group of single-core processors in parallel. In the embodiments, for simpler explanation, a group of single-core processors in parallel is taken as an example in the description.

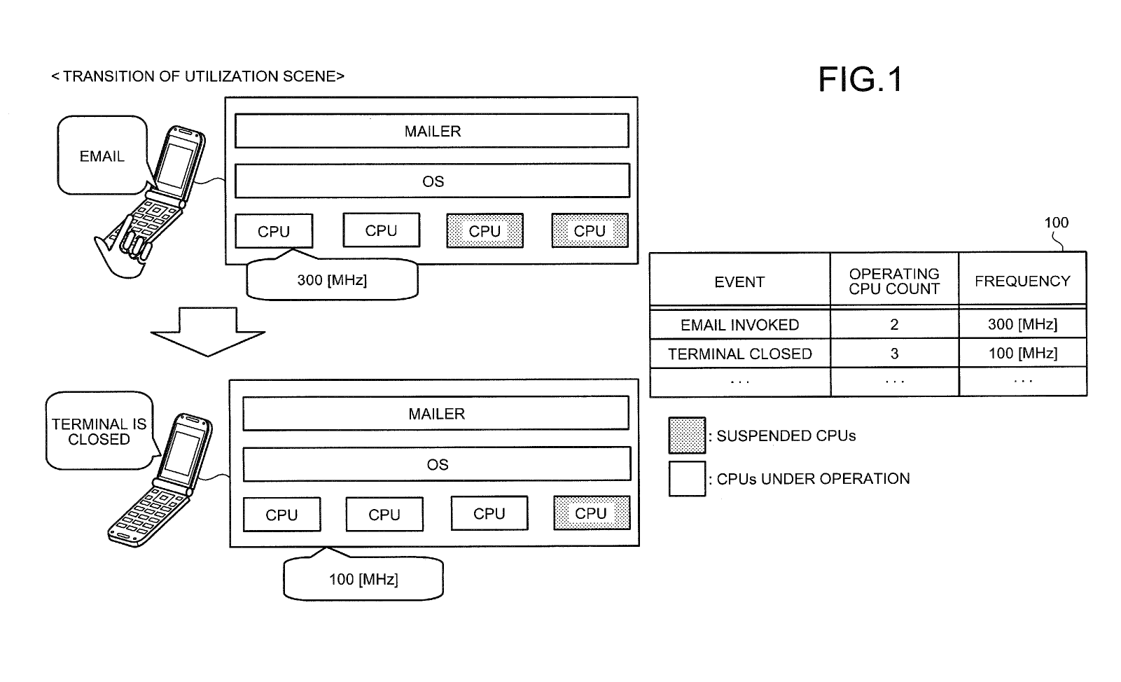

FIG. 1 is an explanatory diagram of an example of the present embodiment. For example, the operating CPU count and a clock frequency are stored for each utilization scene in a table 100. A utilization scene is a situation in which a user is executing a given event, such as starting a specific process of replaying a moving picture, music, etc., executing a main function of the apparatus such as making a call, receiving an incoming e-mail, etc., and opening/closing the apparatus. Because the main functions that an apparatus has is determined at the stage of designing the apparatus, utilization scenes are determined based on the main functions. An OS acquires the operating CPU count and a clock frequency from the table 100 each time a utilization scene is switched.

For example, when an e-mail program is running, the operating CPU count is set to 2 and the frequency of the clock supplied to a CPU under operation is set to 300 [MHz]. When the terminal is closed while the e-mail program is running, the OS acquires from the table 100, the operating CPU count and a clock frequency corresponding to the event of closing the terminal. the operating CPU count is 3 and the frequency is 100 [MHz]. The OS supplies a clock of the acquired frequency to CPUs of the number acquired as the operating CPU count, and executes a program under execution at the CPUs of the number acquired as the operating CPU count.

First to fourth embodiments will be described in detail. The first and second embodiments relate to an example in which each time a utilization scene changes, the apparatus is operated at the CPU count and the clock frequency that correspond to the utilization scene after the change. The third and fourth embodiments relate to an example in which when multiple programs are executed simultaneously, the optimum CPU count and the optimum clock frequency are determined according to the combination of programs under execution.

The first embodiment relates to an example in which the CPU count and the clock frequency that correspond to a utilization scene are specified at the design stage.

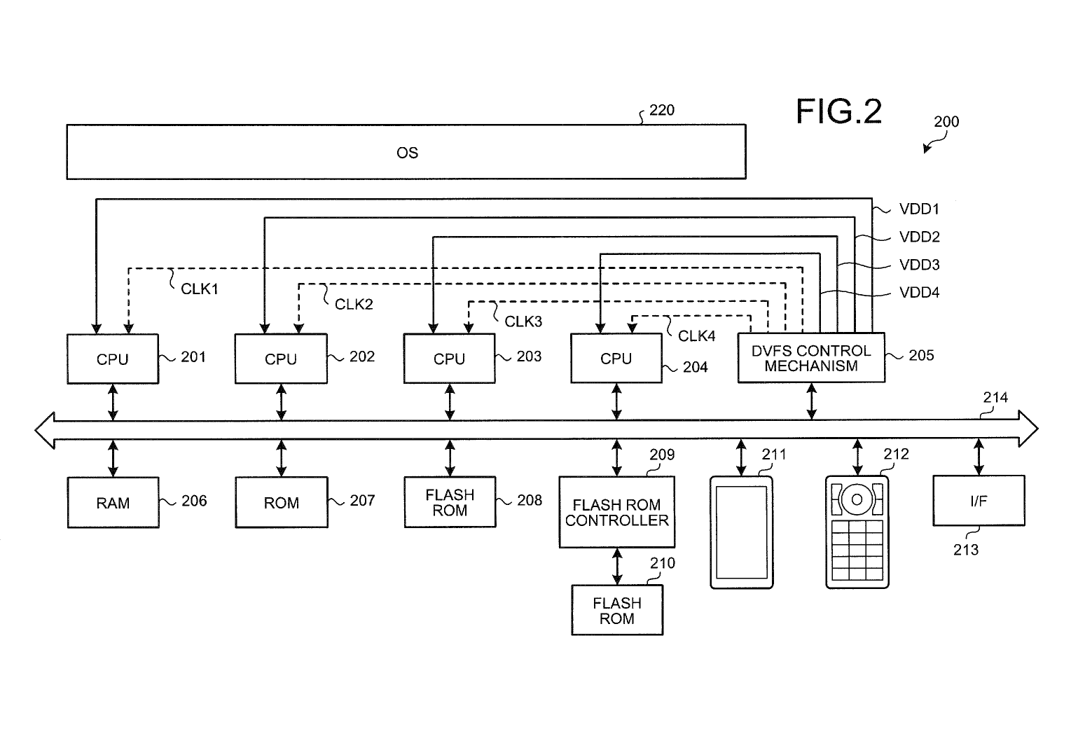

FIG. 2 is an explanatory diagram of an example of hardware of the multi-core processor system. A multi-core processor system 200 includes CPUs 201 to 204, a DVFS control mechanism 205, random access memory (RAM) 206, read-only memory (ROM) 207, and flash ROM 208. The multi-core processor system 200 further includes a flash ROM controller 209, flash ROM 210, a display 211, a keyboard 212, and an interface (I/F) 213. The respective components are connected by a bus 214.

Each of the CPUs 201 to 204 has a register, a core, and a cache. The CPUs 201 to 204 execute a symmetric multiprocessing (SMP) type OS 220. According to the SMP type OS 220, logically speaking, a process internally handled by the OS 220 and an application program running on the OS 220 are executed at each CPU, with few exceptions. The processes are executed by the CPUs in the multi-core processor, but knowing at which CPU a process is executed is unnecessary.

The SMP type OS 220, therefore, does not need to know the number of CPUs under operation, and assigns processes properly to the CPUs under operation. As a result, software can put the apparatus in operation at various numbers of CPUs without being subjected to a specific modification. Actually, only the core of the OS 220 operates independently at each CPU, so that the process that is to be executed at a given CPU is determined as the core handles communication between CPUs.

The ROM 207, the RAM 206, the flash ROM 208, the flash ROM controller 209, the flash ROM 210 are memory shared by the CPUs 201 to 204.

The flash ROM 208 and the ROM 207 store programs such as a boot-loader describing a boot sequence. The flash ROM 208 and the ROM 207 store system software and applications of the OS, and tables controlled by the OS 220.

The RAM 206 is used as a work area by the CPUs. The flash ROM controller 209, under the control of the CPUs, controls the reading and writing of data to the flash ROM 210. The flash ROM 210 stores the data written thereto under the control of the flash ROM controller 209. The data is, for example, image data, moving picture data, etc. acquired via the I/F 213, by a user of the multi-core processor system 200. A memory card, SD card, etc. may be adopted as the flash ROM 210.

The DVFS control mechanism 205 supplies a source voltage and a clock to each CPU. For example, the DVFS control mechanism 205 can supply a source voltage of 1.0 [V] to 1.6 [V] and 0 [V], in units of 0.1 [V], to the CPUs 201 to 204. The control mechanism 205 supplies the source voltage to the CPUs 201 to 204 via respective power lines VDD1 to VDD4. The DVFS control mechanism 205 can supply a clock of a frequency of 100 [MHz] to 500 [MHz] and 0 [MHz], in units of 100 [MHz], to the CPUs 201 to 204. The control mechanism 205 supplies the clock to the CPUs 201 to 204 via respective clock lines CLK 1 to CLK4. If the supplied source voltage is 0 [V] or the frequency of the supplied clock is 0 [Hz], the CPU stops operating.

The display 211 displays, for example, data such as text, images, functional information, etc., in addition to a cursor, icons, and/or tool boxes. The display 211 may be a touch panel having keys for entering numerals, various instructions, etc. and may be used for data input. A thin-film-transistor (TFT) liquid crystal display and the like may be employed as the display 211. The keyboard 212 has keys for entering numerals, various instructions, etc. and is used for data input. Further the keyboard 212 may be a touch panel type input pad, a numeric keypad, etc.

The I/F 213 is connected to a network such as a local area network (LAN), a wide area network (WAN), and the Internet through a communication line and is connected to other apparatuses through the network. The I/F 213 administers an internal interface with the network and controls the input and output of data with respect to external apparatuses. For example, a modem or a LAN adaptor may be employed as the I/F 213.

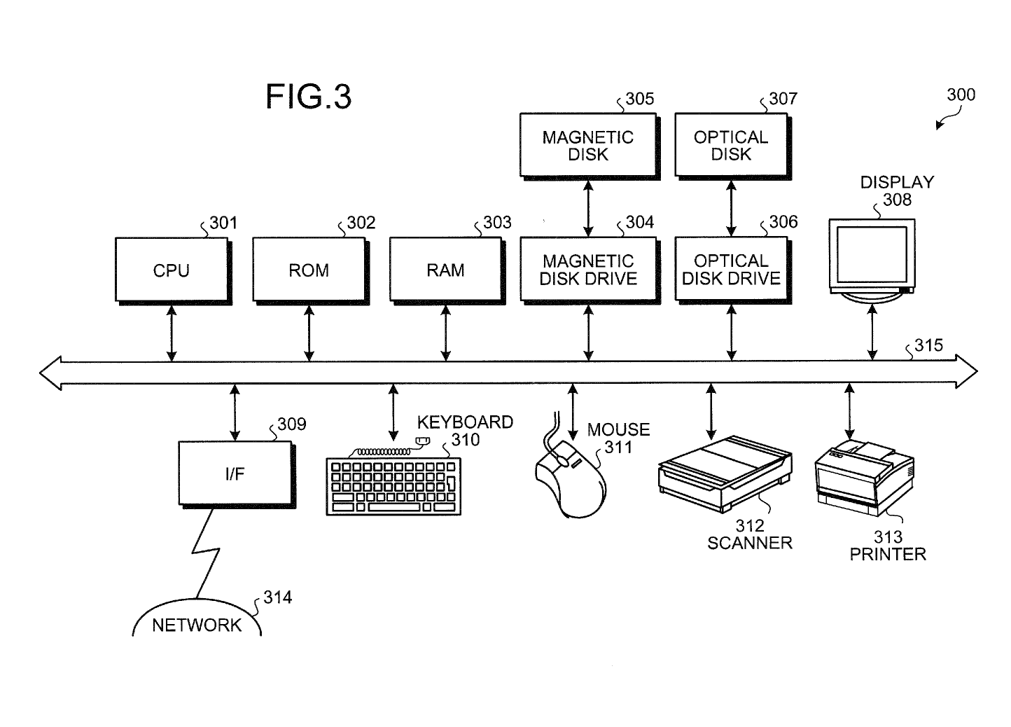

FIG. 3 is a block diagram of a hardware configuration of a system design support apparatus 300 according to the embodiments. As depicted in FIG. 3, the system design support apparatus 300 includes a central processing unit (CPU) 301, a read-only memory (ROM) 302, a random access memory (RAM) 303, a magnetic disk drive 304, a magnetic disk 305, an optical disk drive 306, an optical disk 307, a display 308, an interface (I/F) 309, a keyboard 310, a mouse 311, a scanner 312, and a printer 313, respectively connected by a bus 315.

The CPU 301 governs overall control of the system design support apparatus 300. The ROM 302 stores therein programs such as a boot program. The RAM 303 is used as a work area of the CPU 301. The magnetic disk drive 304, under the control of the CPU 301, controls the reading and writing of data with respect to the magnetic disk 305. The magnetic disk 305 stores therein data written under control of the magnetic disk drive 304.

The optical disk drive 306, under the control of the CPU 301, controls the reading and writing of data with respect to the optical disk 307. The optical disk 307 stores therein data written under control of the optical disk drive 306, the data being read by a computer.

The display 308 displays, for example, data such as text, images, functional information, etc., in addition to a cursor, icons, and/or tool boxes. A cathode ray tube (CRT), a thin-film-transistor (TFT) liquid crystal display, a plasma display, etc., may be employed as the display 308.

The I/F 309 is connected to a network 314 such as a local area network (LAN), a wide area network (WAN), and the Internet through a communication line and is connected to other apparatuses through the network 314. The I/F 309 administers an internal interface with the network 314 and controls the input/output of data from/to external apparatuses. For example, a modem or a LAN adaptor may be employed as the I/F 309.

The keyboard 310 includes, for example, keys for inputting letters, numerals, and various instructions and performs the input of data. Alternatively, a touch-panel-type input pad or numeric keypad, etc. may be adopted. The mouse 311 is used to move the cursor, select a region, or move and change the size of windows. A track ball or a joy stick may be adopted provided each respectively has a function similar to a pointing device.

The scanner 312 optically reads an image and takes in the image data into the system design support apparatus 300. The scanner 312 may have an optical character reader (OCR) function as well. The printer 313 prints image data and text data. The printer 313 may be, for example, a laser printer or an ink jet printer.

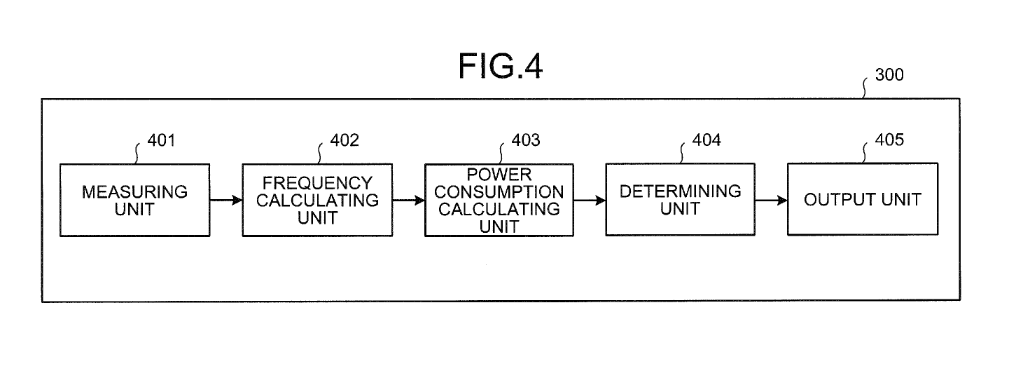

FIG. 4 is an explanatory diagram of a functional block configuration of the system design support apparatus 300 according to the first embodiment. The system design support apparatus 300 includes a measuring unit 401, a frequency calculating unit 402, a power consumption calculating unit 403, a determining unit 404, and an output unit 405. For example, a program having the measuring unit 401 to the output unit 405 is stored in a memory device, such as the ROM 302, magnetic disk 305, and optical disk 307. The CPU 301 accesses a storage device, reads out the program, and executes a process coded in the program. In this manner, processes by the measuring unit 401 to output unit 405 are executed.

When a subject event occurs in the apparatus having the multi-core processor system 200, the measuring unit 401 measures for each count of operating CPUs, an operation time and a total idle time resulting at the time of execution of a process corresponding to the subject event, at a reference frequency. An idle time is a time during which the OS 220 has no process to assign to the CPUs. In the case of the multi-core processor system 200, an idle time arises irregularly at each CPU. For this reason, the measuring unit 401 measures the total of idle times that arise at all CPUs under operation while the measuring unit 401 executes a typical process, as a total idle time. Because the OS 220 manages operation times and idle times in the multi-core processor system 200, the system design support apparatus 300 causes the OS 220 to measure an operation time and a total idle time.

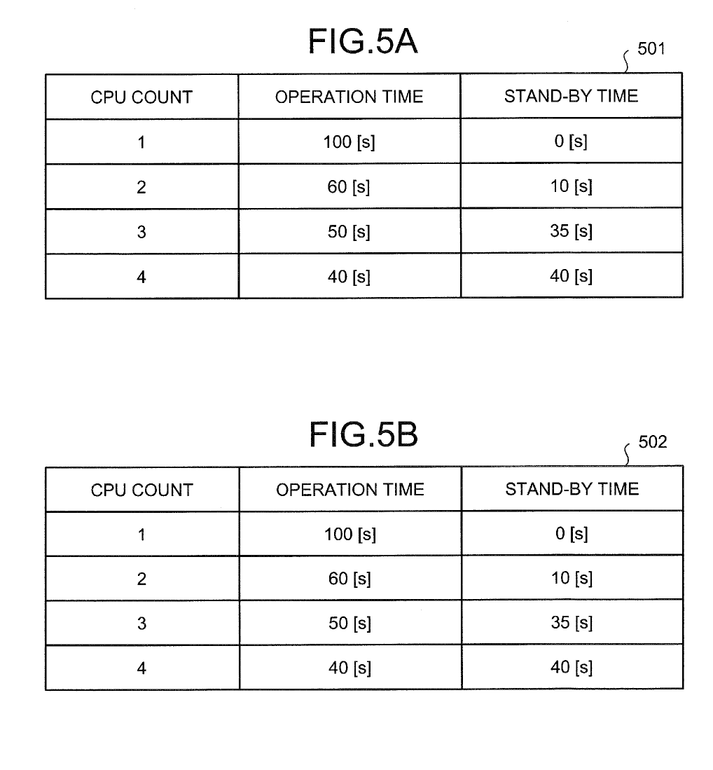

FIGS. 5A and 5B are explanatory diagrams of an example of measurement data. In FIG. 5A, utilization scene 1 measurement data 501 has a CPU count field, an operation time field, and a stand-by time field. Since the multi-core processor system 200 has 4 CPUs, 1 to 4 are entered in the CPU count field. In the operation time field, operation times at the respective CPU counts in the utilization scene 1 are entered. In the stand-by time field, idle times at the respective CPU counts in the utilization scene 1 are entered.

In FIG. 5B, utilization scene 2 measurement data 502 has a CPU count field, an operation time field, and a stand-by time field. Since the multi-core processor system 200 has 4 CPUs, 1 to 4 are entered in the CPU count field. In the operation time field, operation times at the respective CPU counts in the utilization scene 2 are entered. In the stand-by time field, idle times at the respective CPU counts in the utilization scene 2 are entered. The utilization scene 1 measurement data 501 and utilization scene 2 measurement data 502 are stored in a storage device, such as the ROM 302, magnetic disk 305, and optical disk 307.

Reference of the description returns to FIG. 4. Based on the ratio between the operation time at the CPU count measured by the measuring unit 401 and the operation time for each CPU count measured by the measuring unit 401, the frequency calculating unit 402 calculates for each CPU count, a frequency meeting a requirement for the operation time at the specified CPU count. In this example, the specified CPU count is 1. For example, the CPU calculates a frequency for each CPU count, using equation (1).

Frequency=reference frequency×measured operation time/operation time at specified CPU count (1)

The power consumption calculating unit 403 calculates a power consumption volume for each CPU count, using the power consumption per unit time by 1 CPU corresponding to a frequency calculated by the frequency calculating unit 402 for each CPU count. The power consumption per unit time is stored to a memory device. The determining unit 404 determines the CPU count that minimizes the power consumption volume among the power consumption volumes calculated by the power consumption calculating unit 403 for the respective CPU counts, to be the operating CPU count for the subject event. The output unit 405 outputs the operating CPU count determined by the determining unit 404 and the calculated frequency that are associated with identification information of the subject event.

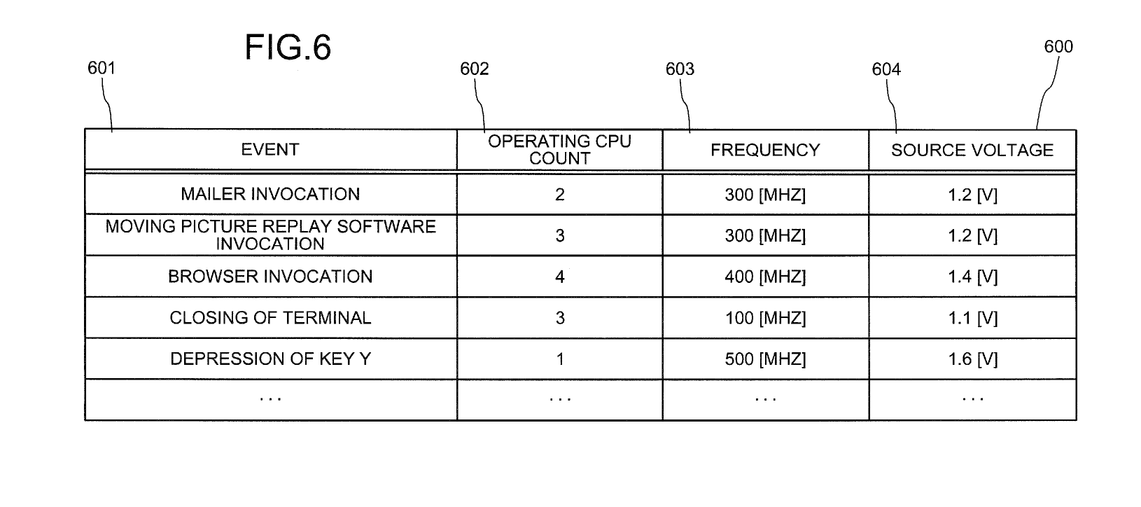

FIG. 6 is an explanatory diagram of an example of a DVFS control information table 600. The DVFS control information table 600 is an instance of an output result. In the DVFS control information table 600, an operating CPU count, a frequency, and a source voltage value are defined for each specified event. The DVFS control information table 600 has an event field 601, an operating CPU count field 602, a frequency field 603, and a source voltage field 604.

The event field 601 indicates utilization scene transition conditions. In this example, the event field 601 indicates “starting the mailer”, “starting the moving picture replay software”, “starting the browser”, “closing the terminal”, and “depressing the key Y”. The operating CPU count field 602 indicates operating CPU counts. The frequency field 603 indicates the frequencies of a clock supplied to the operating CPUs. The source voltage field 604 indicates source voltages supplied to CPUs under operation.

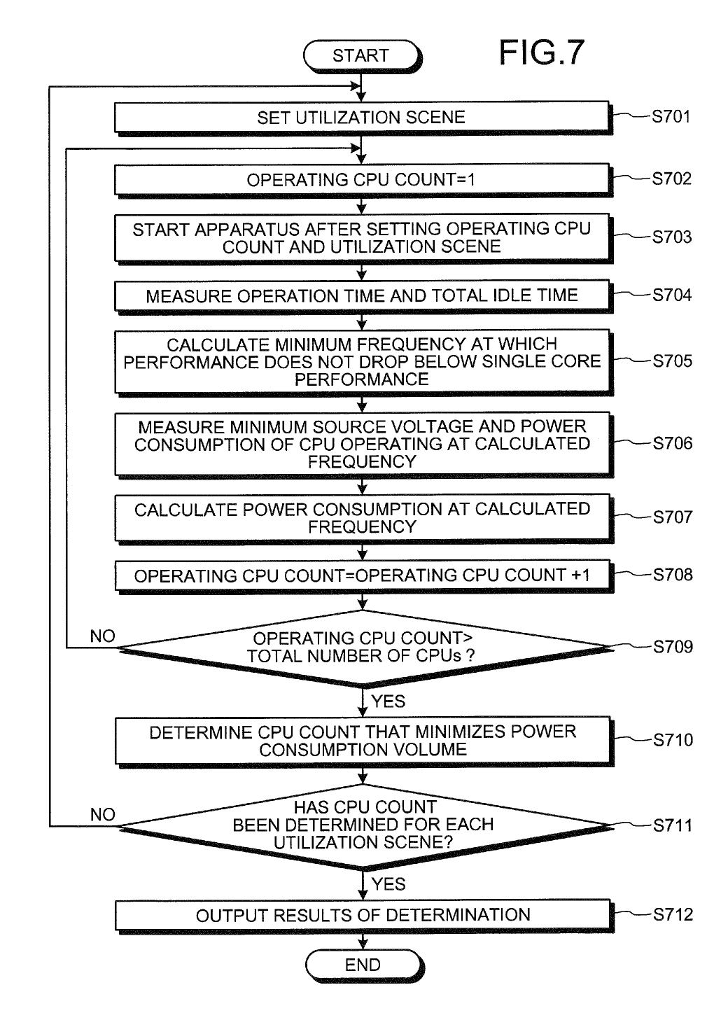

FIG. 7 is a flowchart of an example of a design support procedure by the system design support apparatus 300 of the first embodiment. The system design support apparatus 300 sets an arbitrary utilization scene selected from among utilization scenes for which the operating CPU count is not determined (step S701), sets the operating CPU count to 1 (step S702), and starts the apparatus after setting the operating CPU count and the utilization scene (step S703). The apparatus includes the multi-core processor system 200. The system design support apparatus 300 measures an operation time and a total idle time (step S704), and calculates the minimum frequency at which the apparatus performance does not drop below performance achieved by a single core configuration (step S705).

The system design support apparatus 300 measures the minimum source voltage at which the CPU operates at the calculated frequency and also measures power consumed at the calculated frequency (step S706) and thereby, calculates a power consumption volume at the calculated frequency (step S707). The system design support apparatus 300 increases the operating CPU count by 1 (step S708), and determines whether the operating CPU count is greater than the total number of CPUs (step S709). If determining that the operating CPU count is not greater than the total number of CPUs (step S709: NO), the system design support apparatus 300 returns to step S702.

If determining that the operating CPU count is greater than the total number of CPUs (step S709: YES), the system design support apparatus 300 determines the CPU count that minimizes the power consumption volume (step S710), and determines whether the CPU count has been determined for each utilization scene (step S711). If determining that the CPU count is not determined for each utilization scene (step S711: NO), the system design support apparatus 300 returns to step S701.

If determining that the CPU count has been determined for each utilization scene (step S711: YES), the system design support apparatus 300 outputs the results of the determination of the CPU counts (step S712), and ends the series of operations. The result is output by, for example, displaying the result on the display 308, printing out the result by the printer 313, or transmitting the result to an external apparatus through the I/F 309. The result may be stored in the memory area, such as the RAM 303, magnetic disk 305, and optical disk 307.

The second embodiment relates to an example in which each time a utilization scene is switched to, a process corresponding to the utilization scene is performed at the operating CPU count and a clock frequency corresponding to the utilization scene, using the operating CPU counts and clock frequencies determined, in the first embodiment, for the utilization scenes.

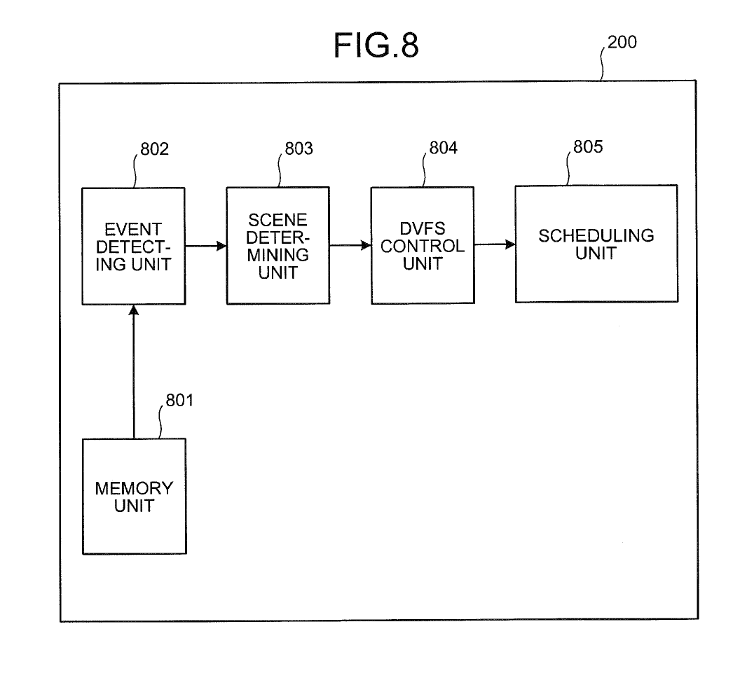

FIG. 8 is a functional block diagram of the multi-core processor system 200 of the second embodiment. The multi-core processor system 200 of the second embodiment includes a memory unit 801, an event detecting unit 802, a scene determining unit 803, a DVFS control unit 804, and a scheduling unit 805.

For example, a program having the event detecting unit 802 to the scheduling unit 805 is stored in a storage device, such as the ROM 207. A CPU accesses the storage device, reads out the program, and executes a process coded in the program. In this manner, processes by the unit 802 to the scheduling unit 805 are executed. The program is the OS 220.

The memory unit 801 stores for each event, a CPU count, a frequency, and a source voltage value that maintain performance achieved in a case of execution of the process at the specified CPU count and that minimize power consumption. For example, the DVFS control information table 600 is stored in the ROM 207 and the flash ROM 208.

The event detecting unit 802 detects an event, and the scene determining unit 803 determines whether the event detected by the event detecting unit 802 is included in events listed in the DVFS control information table 600. If it is determined that the event (subject event) detected by the event detecting unit 802 is included in the events listed in the DVFS control information table 600, the DVFS control unit 804 acquires the operating CPU count for the subject event stored in the memory unit 801, and also acquires a frequency for the subject event stored in the memory unit 801. The DVFS control unit 804 supplies a clock of the acquired frequency to CPUs of the acquired operating CPU count.

If the number of CPUs under operation is greater than the operating CPU count in the multi-core processor, the DVFS control unit 804 suspends CPUs of the number by which the number of CPUs under operation exceeds the operating CPU count. If the number of CPUs under operation is less than the operating CPU count in the multi-core processor, the DVFS control unit 804 starts CPUs of the number by which the number of CPUs under operation falls short of the operating CPU count. The scheduling unit 805 causes the CPUs of the operating CPU count to execute a process corresponding to the subject event. Based on the above description, a specific example will be explained in detail.

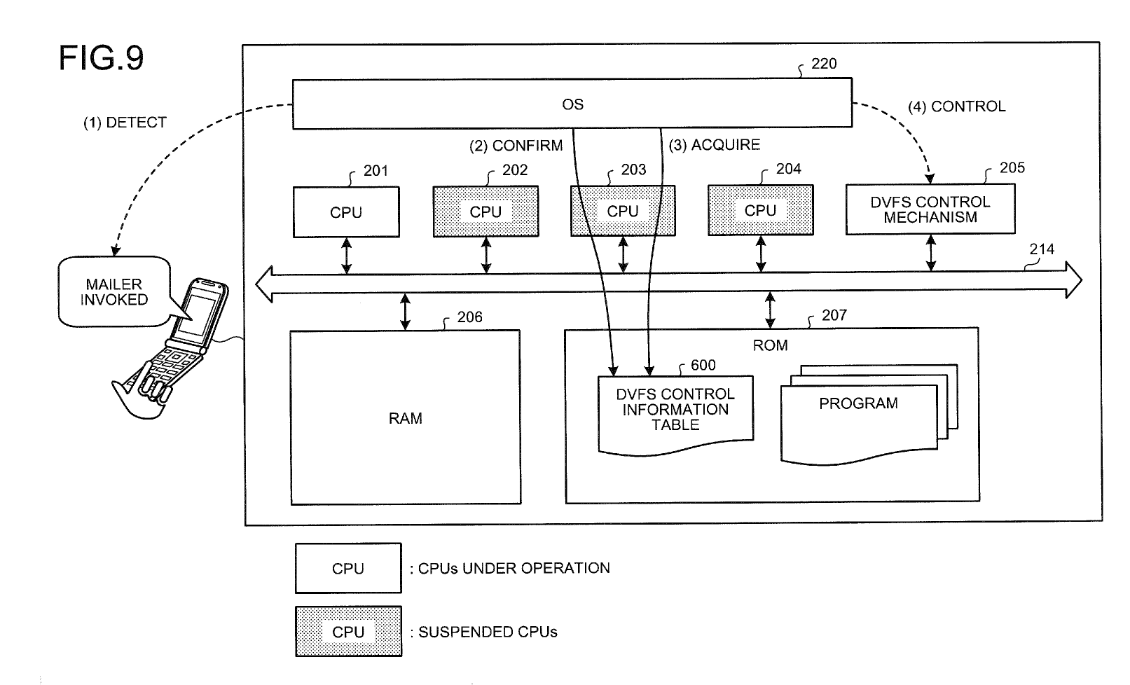

FIG. 9 is an explanatory diagram of an example of the occurrence of an event. In FIG. 9, the CPU 201 is under operation while the CPUs 202 to 204 are suspended. When the user starts the mailer, the OS 220 (1) detects a mailer start instruction. The OS 220 (2) checks the DVFS control information table 600 to see if “starting the mailer” is entered in the event field 601. Confirming that “starting the mailer” is entered in the event field 601 of the DVFS control information table 600, the OS 220 determines that a utilization scene transition condition is met.

The OS 220 (3) acquires from the DVFS control information table 600, the operating CPU count, the clock frequency, and the source voltage value for the start of the mailer. The OS 220 compares the number of CPUs currently under operation and the acquired operating CPU count, thereby determines whether it is necessary to change the number of CPUs under operation. The number of CPUs currently under operation is 1, while the acquired operating CPU count is 2. The number of CPUs that are lacking is, therefore, 1.

To increase the number of CPUs under operation by 1, the OS 220 determines a CPU selected from among the suspended CPUs to be a CPU that is to be started. In this example, the CPU 202 is determined to be the CPU that is to be started. The OS 220 (4) controls the DVFS control mechanism 205 so that the acquired source voltage value and the acquired clock frequency are supplied to the CPUs 201 and 202.

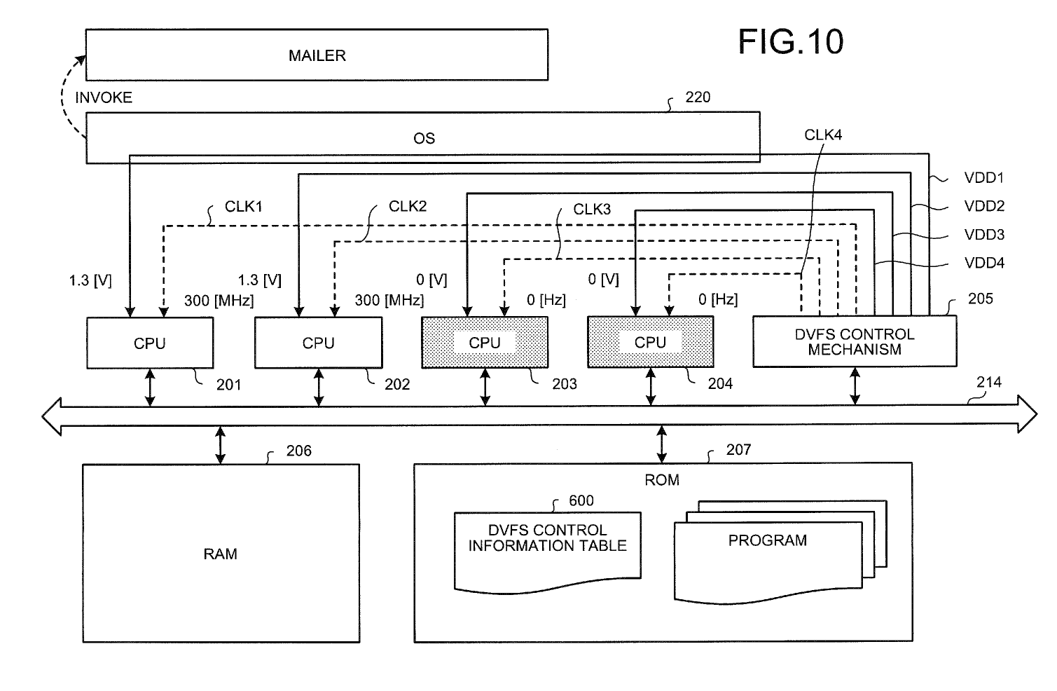

FIG. 10 is an explanatory diagram of an example in which the number of CPUs under operation changes. A source voltage on the power lines VDD1 and VDD2 is 1.3 [V] and a clock frequency on the clock lines CLK1 and CLK2 is 300 [MHz]. A source voltage on the power lines VDD3 and VDD4 is 0 [V] and a clock frequency on the clock lines CLK3 and CLK4 is 0 [MHz]. The OS 220 starts the mailer.

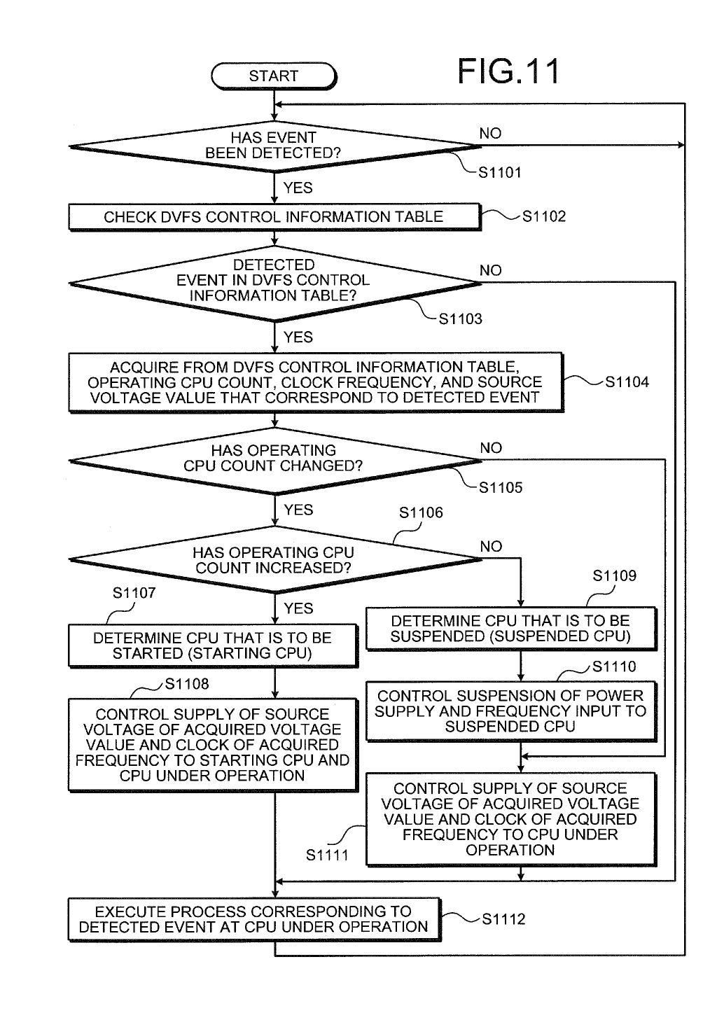

FIG. 11 is a flowchart of an example of a control procedure by the OS 220 of the second embodiment. The OS 220 determines whether an event has been detected (step S1101). If determining that no event has been detected (step S1101: NO), the OS 220 returns to step S1101.

If determining that an event has been detected (step S1101: YES), the OS 220 checks utilization scene transition conditions in the DVFS control information table 600 (step S1102). The OS 220 determines whether the detected event matches any one of the utilization scene transition conditions (step S1103). If determining that the event does not match any one of the utilization scene transition conditions (step S1103: NO), the OS 220 proceeds to step S1112.

If determining that the detected event matches any one of the utilization scene transition conditions (step S1103: YES), the OS 220 acquires from the DVFS control information table 600, the operating CPU count, the clock frequency, and the source voltage value that correspond to the detected event (step S1104). The OS 220 then determines whether the operating CPU count has changed (step S1105). If determining that the operating CPU count has not changed (step S1105: NO), the OS 220 proceeds to step S1111.

If determining that the operating CPU count has changed (step S1105: YES), the OS 220 determines whether the operating CPU count has increased (step S1106). If determining that the operating CPU count has increased (step S1106: YES), the OS 220 determines a CPU selected from among suspended CPUs to be a CPU that is to be started (starting CPU) (step S1107). The OS 220 performs control for supplying the source voltage of the acquired voltage value and the clock of the acquired frequency to the starting CPU and a CPU under operation (step S1108), and proceeds to step S1112.

If determining that the operating CPU count has not increased (step S1106: NO), the OS 220 determines a CPU that is to be suspended (suspended CPU) (step S1109), and performs control for suspending the power supply and frequency input to the suspended CPU (step S1110). The OS 220 performs control for supplying the source voltage of the acquired voltage value and the clock of the acquired frequency to the CPU under operation (step S1111). If “NO” results at step S1103, the OS 220 executes a process corresponding to the detected event at the CPU under operation (step S1112), following step S1108 or step S1111, and proceeds to step S1101.

The third embodiment relates to an example in which the processing time for each CPU count at the reference frequency is measured for each program and a power consumption volume per unit time by 1 core is measured for each frequency.

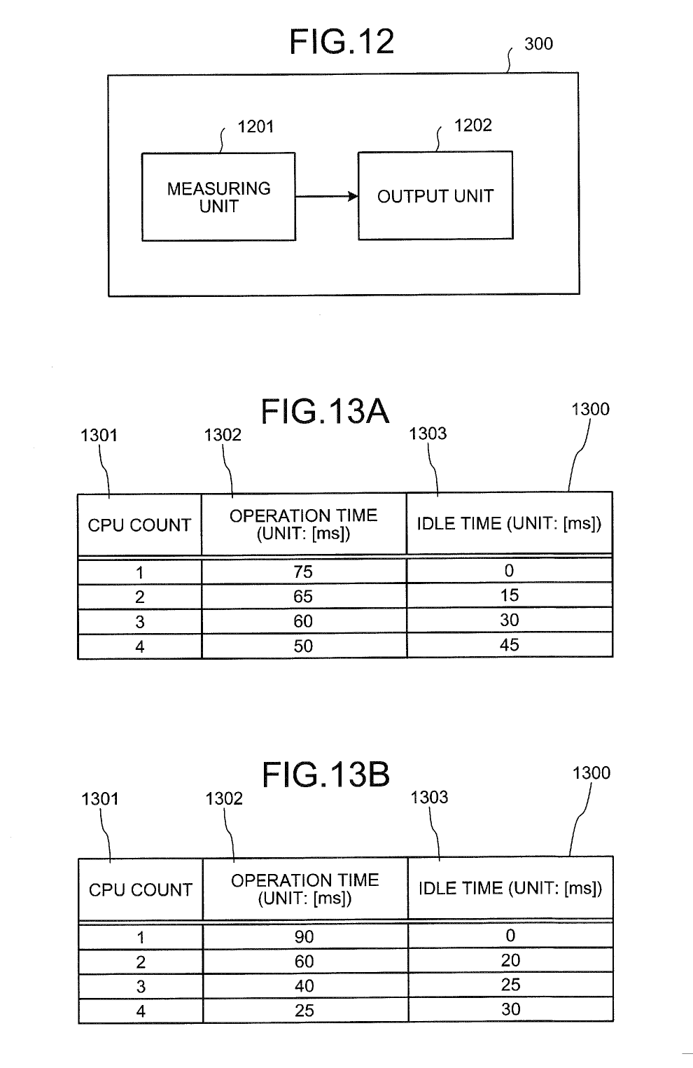

FIG. 12 is an explanatory diagram of a functional block configuration of the system design support apparatus 300. The system design support apparatus 300 includes a measuring unit 1201 and an output unit 1202. For example, a program having the measuring unit 1201 and the output unit 1202 is stored in a storage device, such as the ROM 302, magnetic disk 305, and optical disk 307. The CPU 301 accesses a storage device, reads out the program, and executes a process coded in the program. In this manner, processes by the measuring unit 1201 and the output unit 1202 are executed.

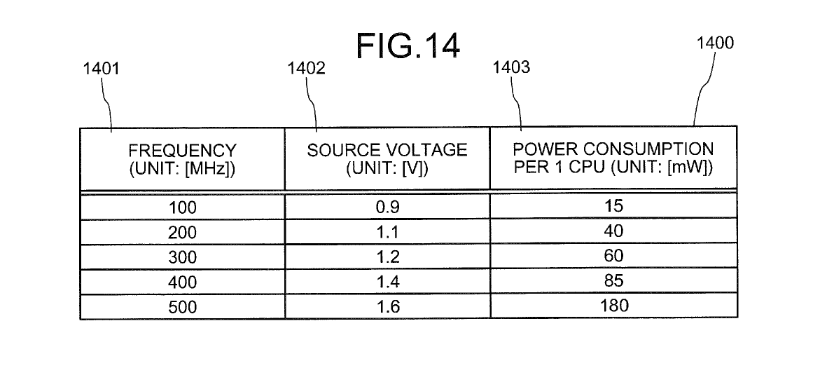

The measuring unit 1201 measures for each program, an operation time for each CPU count at the reference frequency, using the apparatus having the multi-core processor system 200. The output unit 1202 outputs the result of the measurement and identification information of the program that are associated with each other. FIGS. 13A AND 13B depicts an example of output from the output unit 1202.

FIGS. 13A and 13B are explanatory diagrams of examples of operation time tables. An operation time table 1300 in FIG. 13A is, for example, a table in which operation times for the mailer are entered. In the operation time table 1300, each operation time that is taken when the mailer is executed at each CPU count is entered. An operation time table 1310 in FIG. 13B is, for example, a table in which operation times for the browser are entered. In the operation time table 1310, the operation time consumed when the browser is executed at each CPU count is entered.

The operation time table 1300 has a CPU count field 1301, an operation time field 1302, and idle time field 1303. The CPU count field 1301 indicates 1 to 4. The operation time field 1302 indicates the operation time per unit time consumed when the mailer is executed at each CPU count indicated in the CPU count field 1301. The idle time field 1303 indicates the total idle time that arises when the mailer is executed at each CPU count indicated in the CPU count field 1301.

The operation time table 1310 has a CPU count field 1311, an operation time field 1312, and idle time field 1313. The CPU count field 1311 indicates 1 to 4. The operation time field 1312 indicates the operation time per unit time consumed when a browser is executed at each CPU count indicated in the CPU count field 1311. The idle time field 13103 indicates the total idle time that arises when the mailer is executed at each CPU count indicated in the CPU count field 1311.

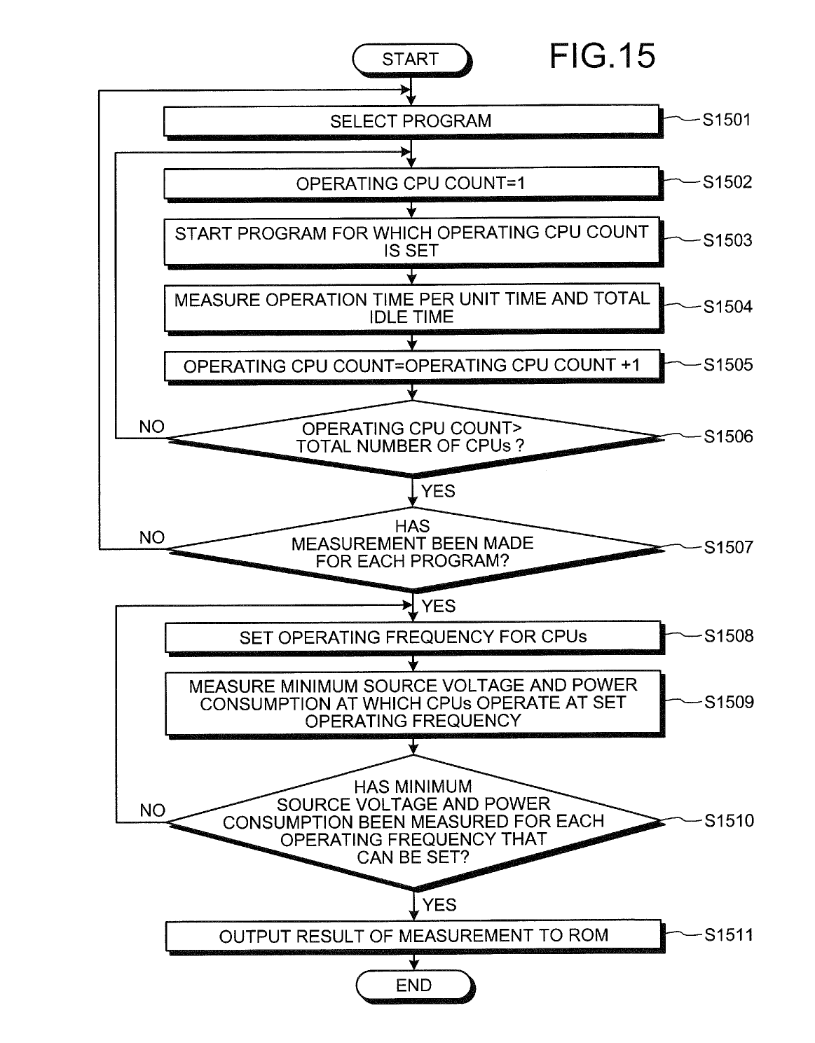

Reference of the description returns to FIG. 12. The measuring unit 1201 measures the power consumption volume per unit time by 1 CPU, for each frequency. The output unit 1203 outputs the result of the measurement. FIG. 14 depicts an example of output from the output unit 1203.

FIG. 14 is an explanatory diagram of an example of a frequency/power table. A frequency/power table 1400 has a frequency field 1401, a source voltage field 1402, and a power consumption per 1 CPU field 1403. The frequency/power table 1400 indicates the frequencies of a clock that can be supplied to each CPU. In this example, the frequency/power table 1400 indicates 100 [MHz], 200 [MHz], 300 [MHz], 400 [MHz], and 500 [MHz].

The source voltage field 1402 indicates the source voltage value that is necessary when the clock is supplied at the frequency indicated in the frequency field 1401. For example, the frequency/power table 1400 indicates that when the frequency of the supplied clock is 500 [MHz], the CPU does not operate unless the supplied source voltage is 1.6 [V] or higher.

The power consumption by 1 CPU field 1403 indicates the value of power consumption by 1 CPU for a case of the supplied clock having the frequency value indicated in the frequency field 1401 and the supplied source voltage having the value indicated in the source voltage field 1402. For example, the frequency/power table 1400 indicates that when the frequency of the clock supplied to the CPU is 200 [MHz] and the source voltage supplied to the CPU is 1.1 [V], the power consumption by 1 CPU is 40 [mW].

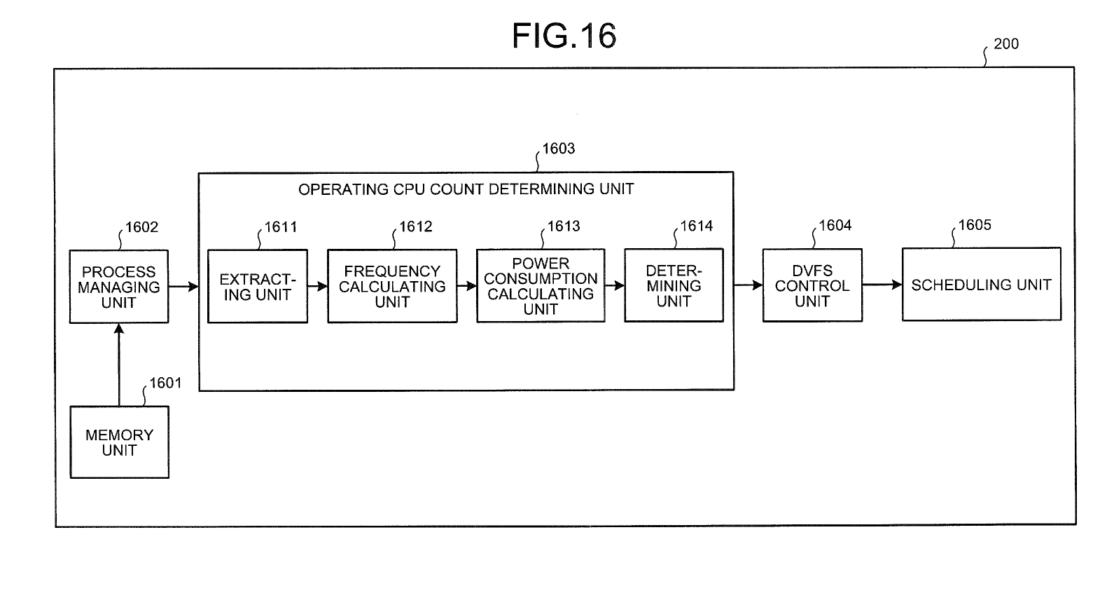

FIG. 15 is a flowchart of an example of a design support procedure by the system design support apparatus 300 of the third embodiment. The system design support apparatus 300 selects an arbitrary program from among programs for which no measurement has been made (step S1501), sets the operating CPU count to 1 (step S1502), and starts the program for which the operating CPU count is set (step S1503). The system design support apparatus 300 then measures the operation time per unit time and a total idle time (step S1504).

The system design support apparatus 300 increases the operating CPU count by 1 (step S1505), and determines whether the operating CPU count is greater than the total number of CPUs (step S1506). If determining that the operating CPU count is not greater than the total number of CPUs (step S1506: NO), the system design support apparatus 300 returns to step S1502. If determining that the operating CPU count is greater than the total number of CPUs (step S1506: YES), the system design support apparatus 300 determines whether measurement has been made for each program (step S1507).

If determining that measurement has not been made for each program (step S1507: NO), the system design support apparatus 300 returns to step S1501. If determining that measurement has been made for each program (step S1507: YES), the system design support apparatus 300 sets an operating frequency for CPUs (step S1508), and measures the minimum source voltage and power consumption at which the CPUs operate at the set operating frequency (step S1509).

The system design support apparatus 300 determines whether the minimum source voltage and power consumption has been measured for each operating frequency that can be set (step S1510). If determining that the minimum source voltage and power consumption has not been measured for each operating frequency that can be set (step S1510: NO), the system design support apparatus 300 returns to step S1508. If determining that the minimum source voltage and power consumption has been measured for each operating frequency that can be set (step S1510: YES), the system design support apparatus 300 outputs the result of the measurement (step S1511).

The fourth embodiment relates to an example in which when multiple programs are executed simultaneously, the CPU count and the frequency that maintain performance achieved in the case of executing the programs by 1 CPU and that minimize power consumption are identified, and the programs are executed at the identified CPU count and frequency. In the fourth embodiment, constituent elements identical to those described in the first to third embodiments are denoted by the same reference numerals used in the first to third embodiments, and redundant description thereof is omitted.

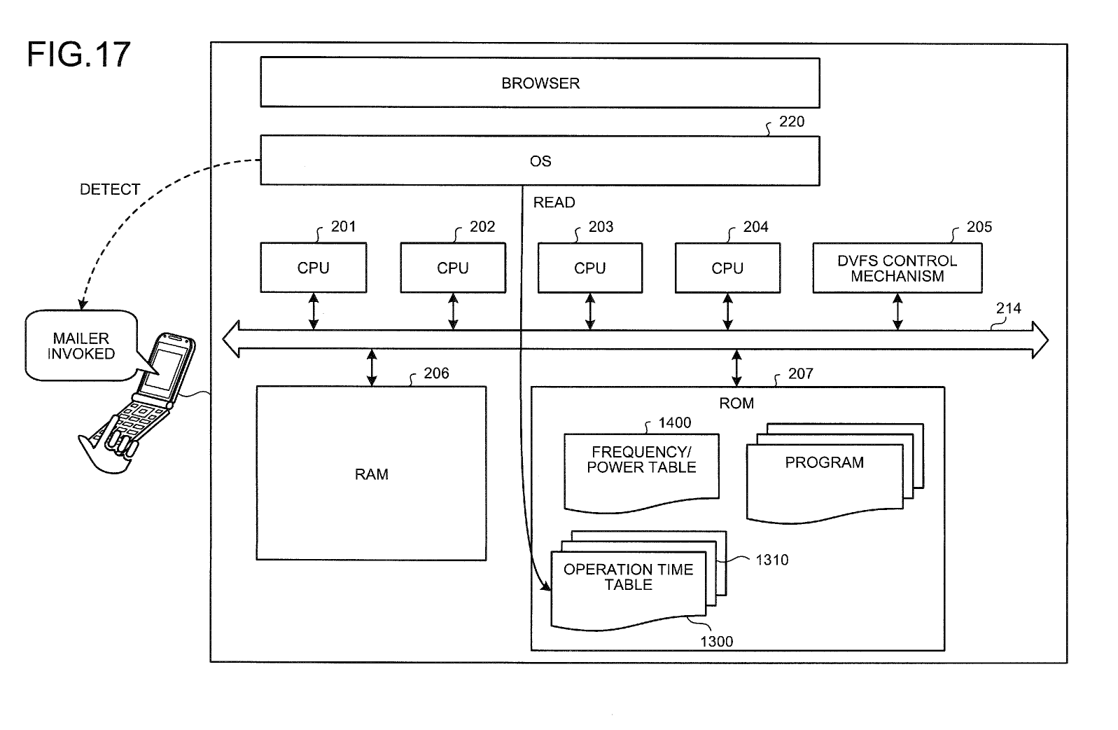

FIG. 16 is a functional block diagram of the multi-core processor system 200 of the fourth embodiment. The multi-core processor system 200 includes a memory unit 1601, a process managing unit 1602, an operating CPU count determining unit 1603, a DVFS control unit 1604, and a scheduling unit 1605.

For example, a program having the process managing unit 1602 to the scheduling unit 1605 is stored in a storage device, such as the ROM 207 and the ROM 208. The CPU accesses a storage device, reads out the program, and executes a process coded in the program. In this manner, processes by the process managing unit 1602 to the scheduling unit 1605 are executed. The program is the OS 220.

The memory unit 1601 stores for each program, an operation time for each CPU count at the reference frequency, and a power consumption volume per unit time by 1 CPU, for each frequency. For example, the ROM 207 and the ROM 208 stores therein the operation time table 1300, the operation time table 1310, and the frequency/power table 1400.

The process managing unit 1602 detects the start of a subject program. the operating CPU count determining unit 1603 determines the operating CPU count that executes the subject program and a program under execution. The operating CPU count determining unit 1603 has an extracting unit 1611, a frequency calculating unit 1612, a power consumption calculating unit 1613, and a determining unit 1614. When the process managing unit 1602 detects the start of the subject program, the extracting unit 1611 extracts from the memory unit 1601, an operation time for a program under execution in the multi-core processor, for each CPU count. The extracting unit 1611 also extracts from the memory unit 1601, an operation time for the subject program, for each CPU count.

The frequency calculating unit 1612 calculates for each CPU count, a frequency that meets a requirement for a total operation time at the specified CPU count, based on the ratio between a total operation time given by totaling the operation time for the program under execution and the operation time for the subject program that are extracted for each CPU count by the extracting unit 1611 and the total operation time at the specified CPU count.

The power consumption calculating unit 1613 calculates a power consumption volume for each CPU count, based on a power consumption per unit time by 1 CPU corresponding to a frequency calculated for each CPU count by the frequency calculating unit 1612. The power consumption per unit time is stored to the memory unit 1601. The determining unit 1614 determiners the CPU count that minimizes the power consumption volume among power consumption volumes calculated for the respective CPU counts by the power consumption calculating unit 1613, to be the operating CPU count.

The DVFS control unit 1604 supplies a clock of a frequency calculated by the operating CPU count determining unit 1603, to CPUs of the CPU count determined by the operating CPU count determining unit 1603. If the number of CPUs under operation is greater than the determined CPU count in the multi-core processor, the DVFS control unit 1604 suspends CPUs of the number by which the number of CPUs under operation exceeds the operating CPU count. If the number of CPUs under operation is less than the determined CPU count in the multi-core processor, the DVFS control unit 1604 starts CPUs of the number by which the number of CPUs under operation falls short of the operating CPU count. The scheduling unit 1605 then causes the CPUs of the determined CPU count to execute the subject program and the program under execution. Based on the above description, detailed explanation will be made.

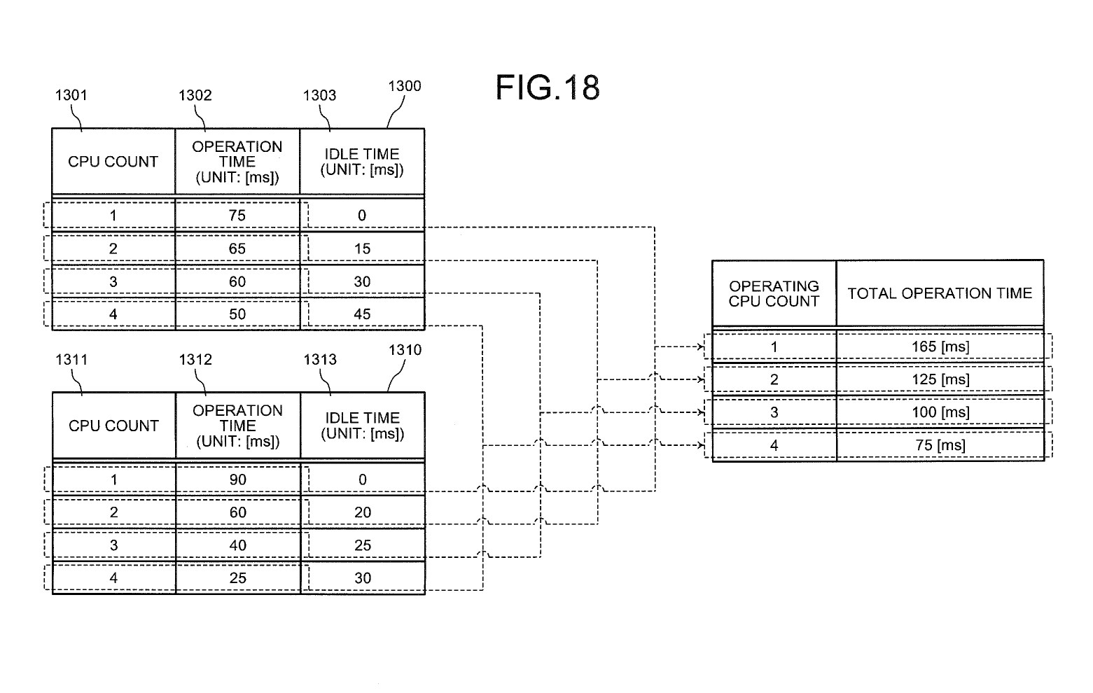

FIG. 17 is an explanatory diagram of an example in which multiple programs are executed simultaneously. In the multi-core processor system 200, the browser is under operation and the operating CPU count is 4. When the user starts the mailer, the OS 220 detects a mailer start instruction. The OS 220 then acquires identification information of the program under execution. The OS 220 acquires an operation time table corresponding to the program of which the identification information is acquired and an operation time table corresponding to the program for which the start instruction is detected. In this example, the operation time table 1300 for the mailer and the operation time table 1310 for the browser are read from a storage device, such as the ROM 207 and the flash ROM 208.

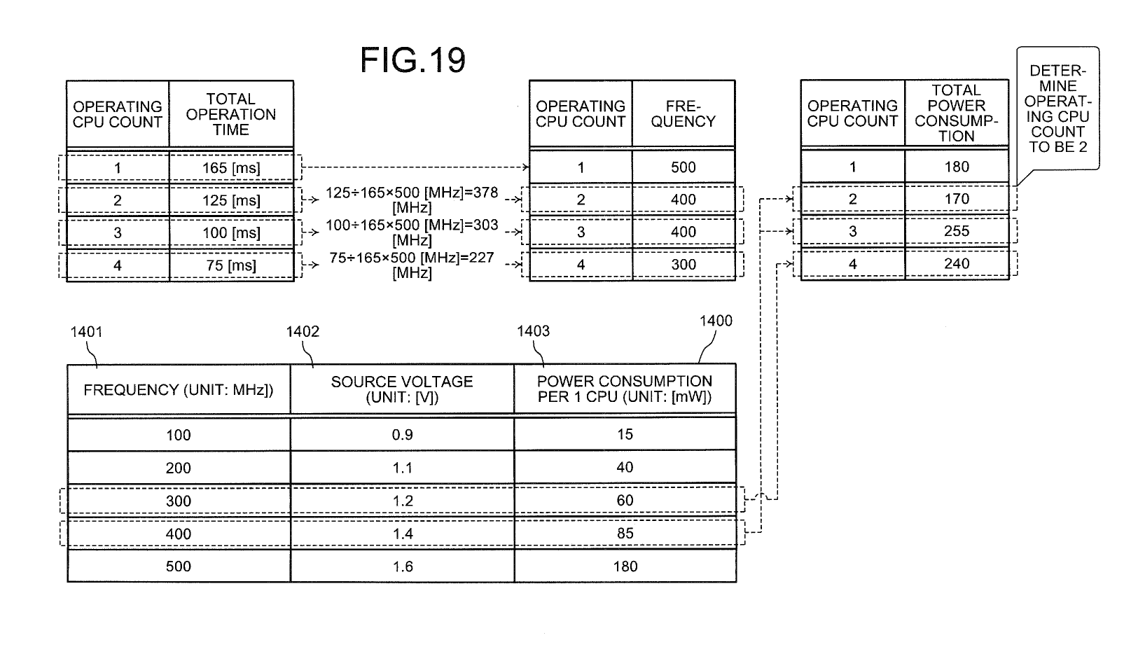

FIG. 18 is an explanatory diagram of a total operation time. The OS 220 calculates a total operation time for the mailer and browser for each CPU count, using the operation time table 1300 and the operation time table 1310. When the CPU count is 1, the total operation time is 165 [ms]. When the CPU count is 2, the total operation time is 125 [ms]. When the CPU count is 3, the total operation time is 100 [ms]. When the CPU count is 4, the total operation time is 75 [ms].

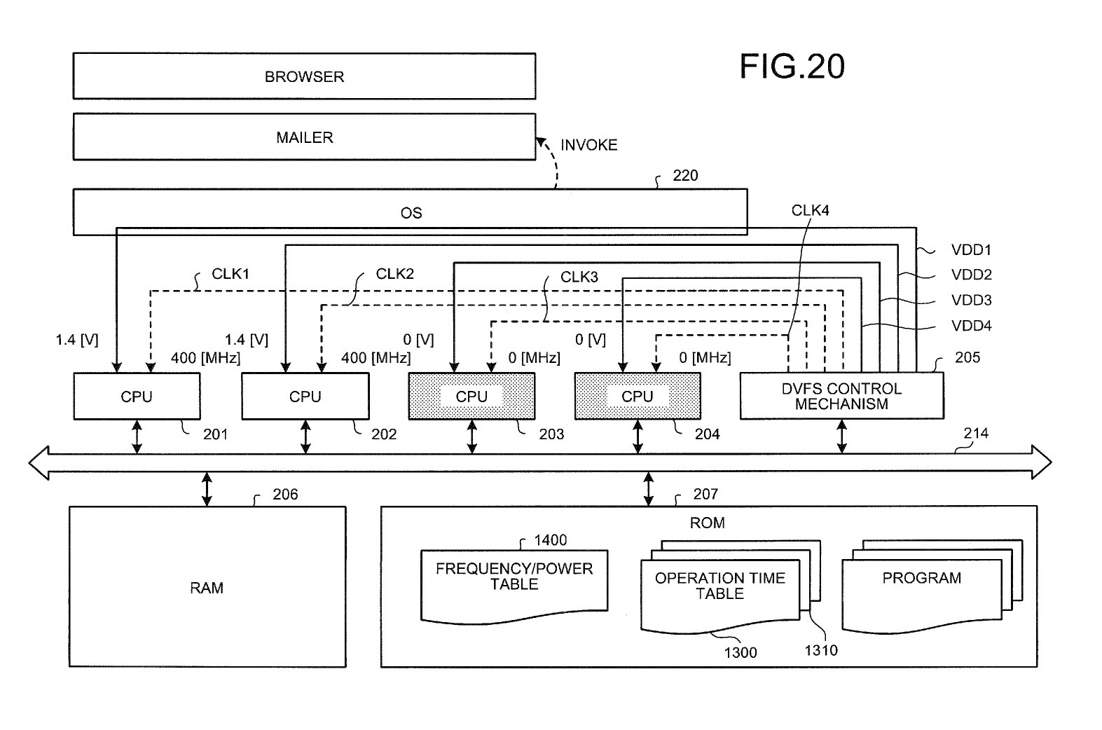

FIG. 19 is an explanatory diagram of an example in which the CPU count that minimizes power consumption is identified. The OS 220 calculates for each CPU count, a clock frequency at which the operation time in the case of the CPU count being 1 can be maintained. For example, the OS 220 calculates the clock frequency for each CPU count, using equation (2).

Frequency=reference frequency×total operation time at each CPU count/total operation time at specified CPU count (2)

In this example, for example, the reference frequency is set to 500 [MHz]. When the CPU count is 2, the equation (2) yields a calculation result of 378 [MHz]. The clock frequency is, therefore, determined to be 400 [MHz]. When the CPU count is 3, the equation (2) yields a calculation result of 303 [MHz]. The clock frequency is, therefore, determined to be 400 [MHz]. When the CPU count is 4, the equation (2) yields a calculation result of 227 [MHz]. The clock frequency is, therefore, determined to be 300 [MHz].

The OS 220 calculates each power consumption value for the case of executing the program at each CPU count, using the frequency/power table 1400. When the frequency is 400 [MHz], power consumption by 1 CPU is 85 [mW]. When the CPU count is 2, therefore, the total power consumption is 85×2=170 [mW], and when the CPU count is 3, the total power consumption is 85×3=255 [mW]. When the frequency is 300 [MHz], power consumption by 1 CPU is 60 [mW]. When the CPU count is 4, therefore, the total power consumption is 60×4=240 [mW]. These calculations lead to a conclusion that the CPU count that maintains the same performance achieved in the case of the CPU count being 1 and that minimizes power consumption is 2. Thus, the OS 220 determines the operating CPU count to be 2.

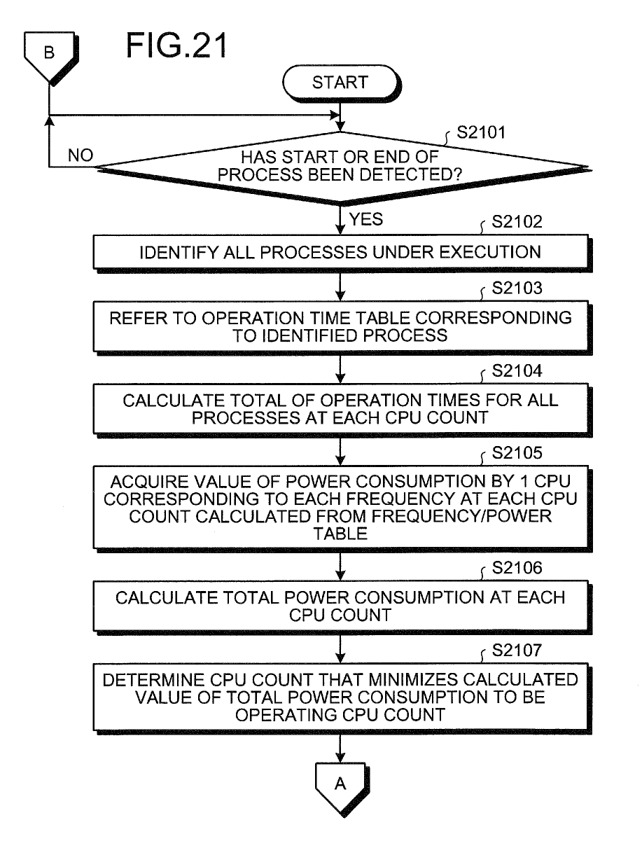

FIG. 20 is an explanatory diagram of an example of a change in the operating CPU count. The OS 220 determines a CPU to suspend (suspended CPU) in order to reduce the operating CPU count. In this example, the CPUs 203 and 204 are determined to be CPUs that are to be suspended. The OS 220 causes the DVFS control mechanism 205 to stop supplying a clock and a source voltage to the CPU 203 and the CPU 204. The OS 220 sets the frequency of a clock supplied to the CPU 201 and the CPU 202, to 400 [MHz], and sets the value of a source voltage supplied to the same, to 1.4 [V].

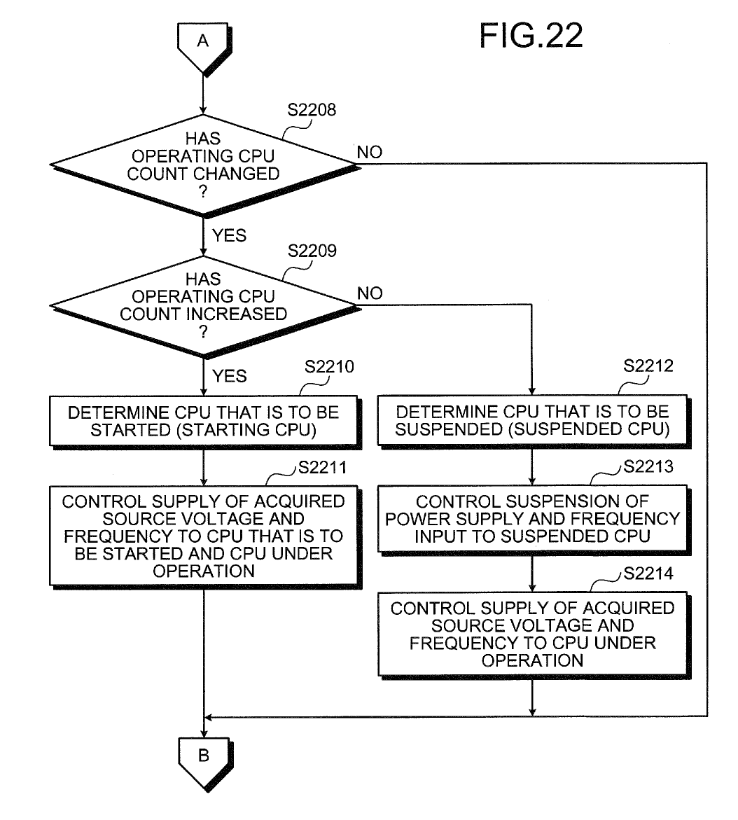

FIGS. 21 and 22 are flowcharts of an example of a control procedure by the OS 220 of the fourth embodiment. The OS 220 determines if the start or end of a process has been detected (step S2101). If determining that neither the end nor the start of a process has been detected (step S2101: NO), the OS 220 returns to step S2101. If determining that the end or the start of a process has been detected (step S2101: YES), the OS 220 identifies all processes under execution (step S2102).

The OS 220 refers to an operation time table corresponding to an identified process (step S2103) and calculates total of operation times for all processes at each CPU count (step S2104). The OS 220 acquires the value of power consumption by 1 CPU corresponding to each frequency at each CPU count calculated from the frequency/power table 1400 (step S2105), and calculates the value of total power consumption at each CPU count (step S2106).

The OS 220 determines the CPU count that minimizes the calculated value of total power consumption to be the operating CPU count (step S2107), and determines whether the operating CPU count has changed (step S2108). If determining that the operating CPU count has not changed (step S2108: NO), the OS 220 proceeds to step S2101.

If determining that the operating CPU count has changed (step S2108: YES), the OS 220 determines whether the operating CPU count has increased (step S2109). If determining that the CPU count has increased (step S2109: YES), the OS 220 determines a CPU selected from among suspended CPUs to be a CPU that is to be started (starting CPU) (step S2110). The OS 220 performs control for supplying an acquired source voltage and frequency to the CPU that is to be started and a CPU under operation (step S2111), and proceeds to step S2101.

If determining that the CPU count has not increased (step S2109: NO), the OS 220 determines a CPU that is to be suspended (suspended CPU) (step S2112), and performs control for suspending power supply and frequency input to the suspended CPU (step S2113). The OS 220 performs control for supplying the acquired source voltage and frequency to the CPU under operation (step S2114), and proceeds to step S2101.

As described in the first and third embodiments above, according to the system design support method, a combination of the operating CPU count and a clock frequency that minimizes the power consumption volume is identified for each event. As a result, the system can be operated at the operating CPU count and the clock frequency that minimize power consumption volume.

For each event, a clock frequency is calculated based on an operation time and a reference frequency in the case of executing a process corresponding to the event by 1 CPU. As a result, performance achieved in the case of executing the process by 1 CPU can be maintained.

As described in the second embodiment above, according to the scheduling method and the system, the operating CPU count and a clock frequency are stored in the memory for each event. Each time a given event occurs, the operating CPU count and a frequency are switched and a process corresponding to the event is executed. As a result, the process corresponding to the event can be executed using a combination of the operating CPU count and the clock frequency that minimizes power consumption. Thus, power consumption can be reduced.

If the number of CPUs under operation is greater than the operating CPU count, CPUs of the number by which the number of CPUs under operation exceeds the operating CPU count are suspended. As a result, the system can be operated at the optimum CPU count that minimizes power consumption.

If the CPU count under operation is less than the operating CPU count, CPUs of the number by which the number of CPUs under operation falls short of the operating CPU count are started. As a result, performance achieved in the case of executing the process by 1 CPU can be maintained.

An operating CPU count, a clock frequency, and a source voltage value are stored in the memory for each event. Each time a given event occurs, the operating CPU count, a frequency, and a source voltage value are switched and a process corresponding to the event is executed. Power consumption is proportional to the square of the frequency and the source voltage. If the clock frequency is lowered, it causes the source voltage to drop, thereby reduces the power consumption volume.

As described in the fourth embodiment above, according to the scheduling method and the system, the operation time in the case of executing the process by CPUs of the CPU count is stored in the memory for each program, and a power consumption volume by 1 CPU is stored in the memory for each frequency. When multiple programs are executed simultaneously, the optimum operating CPU count and the optimum frequency that maintain performance achieved in the case of executing the process by 1 CPU and that minimize power consumption are identified, and the multiple programs are run at the optimum operating CPU count and the optimum frequency. As a result, the power consumption volume is reduced.

If the number of CPUs under operation is greater than the operating CPU count, CPUs of the number by which the number of CPUs under operation exceeds the operating CPU count are suspended. As a result, the system can be operated at the optimum CPU count that minimizes power consumption.

If the CPU count under operation is less than the operating CPU count, CPUs of the number by which the number of CPUs under operation falls short of the operating CPU count are started. As a result, performance achieved in the case of executing the process by 1 CPU can be maintained.

According to one aspect of the present invention, an effect is achieved such that performance of a given level or higher level is maintained and power consumption is reduced as well. According to another aspect of the invention, an effect is achieved such that a combination of the operating CPU count and a clock frequency that minimizes power consumption can be identified easily.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A scheduling method executed by a processor, the scheduling method comprising:
detecting a transition from a first process to a second process;
acquiring from memory, an operating frequency and a CPU count for executing the second process;
suspending a CPU under operation or starting a suspended CPU, based on the CPU count; and
assigning the operating frequency to a CPU that is to execute the second process.

2. The scheduling method according to claim 1, wherein
the suspending a CPU under operation or starting a suspended CPU, based on the CPU count includes suspending CPUs of a number by which CPUs under operation exceeds the CPU count, when the number of CPUs under operation is greater than the CPU count.

3. The scheduling method according to claim 1, wherein
the suspending a CPU under operation or starting a suspended CPU, based on the CPU count includes starting CPUs of a number by which CPUs under operation fall short of the CPU count, when the number of CPUs count under operation is less than the CPU count.

4. The scheduling method according to claim 1, wherein
the acquiring includes acquiring from the memory, the operating frequency, a source voltage value, and the CPU count for executing the second process,
the suspending a CPU under operation or starting a suspended CPU is based on the acquired CPU count, and
the assigning includes assigning the operating frequency and the source voltage value to a CPU that is to execute the second process.

5. A system design support method executed by a processor, the system design support method comprising:
measuring for execution of a first process, a first operation time and a first suspension time for CPUs of a first CPU count;
setting a first operating frequency that is greater than a first minimum operating frequency;
calculating based on the first operation time and the first suspension time, a first power consumption by the CPUs that are of the first CPU count and operating at the first operating frequency;
measuring for the execution of the first process, a second operation time and a second suspension time for CPUs of a second CPU count different from the first CPU count;
setting a second operating frequency that is greater than a second minimum operating frequency;
calculating based on the second operation time and the second suspension time, a second power consumption by the CPUs that are of the second CPU count and operating at the second operating frequency; and
determining based on a result of comparison of the first power consumption and the second power consumption, a CPU count for the execution of the first process.

6. The system design support method according to claim 5, further comprising:
calculating the first minimum operating frequency, based on an operation time consumed when the first process is executed by 1 CPU, the first operation time, and a given operating frequency, and
calculating the second minimum operating frequency, based on the operation time consumed when the first process is executed by 1 CPU, the second operation time, and the given operating frequency.

7. A system comprising:
a plurality of CPUs;
memory storing therein for each of the CPUs, an operating frequency and a CPU count for executing a process, wherein
a CPU among the CPUs is configured to:
suspend a CPU under operation or start a suspended CPU, based on the CPU count; and
set the operating frequency for CPUs of the CPU count.

8. The system according to claim 7, wherein
the CPU suspends CPUs of a number by which CPUs under operation exceeds the CPU count, when the number of CPUs under operation is greater than the CPU count.

9. The system according to claim 7, wherein
the CPU starts CPUs of a number by which CPUs under operation fall short of the CPU count, when the number of CPUs count under operation is less than the CPU count.
